(19) United States
(12) Patent Application Publication
(10) Pub. No.: US 2006/0159265 A1
(43) Pub. Date: Jul. 20, 2006

(54) Communications system and method for transmitting voice and/or data

(75) Inventors: Olivier Tarralle, Blaustein (DE); Juergen Dittrich, Senden (DE); Dieter Olbrich, Laichingen (DE); Daniel Zerbib, Paris (FR); Guillaume Pascal, Buc (FR); Julien Giroux, Triel sur Seine (FR)

Correspondence Address: JANSSON, SHUPE, MUNGER & ANTARAMIAN, LTD, 245 MAIN STREET, RACINE, WI, 53403, US

(73) Assignee: EADS Secure Networks GmbH

(21) Appl. No.: 11/349,289

(22) Filed: Feb. 7, 2006

Related U.S. Application Data
(63) Continuation of application No. PCT/EP04/08817, filed on Aug. 6, 2004.

(30) Foreign Application Priority Data
Aug. 8, 2003 (EP) EP03 018 117.6

(51) Int. Cl. H04N 7/167

(52) U.S. Cl. 380/233

(57) ABSTRACT

A communications system, particularly a PMR system, for transmitting voice and/or data, for a plurality of individual subscribers, is characterized in that each subscriber has at least one subscriber terminal, at least one object characterization is assigned to each subscriber terminal, and upon the object communication request of a subscriber, the communications system establishes an object communication, wherein the assignment of the at least one object characterization takes place only by storing the at least one object characterization in the subscriber terminal, and each subscriber terminal decides on the basis of the object characterization(s) contained therein on the entry into the object communication requested by the subscriber. A method of transmitting voice and/or data is also provided.

### CROSS REFERENCE TO RELATED APPLICATIONS

This application is a continuation of P.C.T. application PCT/EP2004/008817, filed Aug. 6, 2004 by inventors Olivier Tarralle, et al., titled, “Communications System and Method for Transmitting Voice and/or Data,” and claims priority to European Patent Application 03 018 117.6, filed Aug. 8, 2003.

### FIELD OF THE INVENTION

The present invention relates to a communications system, especially a PMR system, for transmitting voice and/or data, for a plurality of individual subscribers as well as to a method of transmitting voice and/or data to a plurality of individual subscribers in a communications system.

### BACKGROUND OF THE INVENTION

A communications system in the form of a radio system is known from DE 39 39 903 A1 for a subscriber structure that is not very organizational or hierarchical. A considerable organizational and processing complexity of radio communications connections, of the subscribers among each other with a central station or with wire-bound subscribers, for a frequently changing group composition and task assignment, is reduced by the radio system.

The radio system of the prior art has a control center and a plurality of subscribers who may be called selectively via their own individual dial numbers, a plurality of object characterizations being provided which can be distinguished from the dial numbers admissible in the system. On demand of a subscriber, which contains an object characterization and the subscriber's own dial number, to the control center, the control center assigns to the subscribers an object-related dial number on the basis of a stored assignment rule, and transmits this number to a subscriber terminal. The dial number in the subscriber terminal assigned by the control center is stored with respect to the object characterization and with respect to the object characterization and subscriber in the control center. An object call request for a radio communication directs an object characterization to the control center, and the control center detects, upon receipt of an object call request according to the defined object characterization and the assigned dial number, a dial number enabling the establishment of the radio communication.

However, the radio system of this prior art reveals some disadvantages. First of all, an assignment of a subscriber to an object characterization must be made in that a request is directed by radio to the control center and then a new dial number is assigned to the requesting subscriber. Only then is communication established after an object call request was transmitted by radio to the control center. Radio systems of this kind, used for instance in an airport, may have many thousands of subscribers so that there is considerable radio traffic. The particular disadvantage of the system of the prior art is therefore the necessity, before establishment of communication with the individual subscribers, of requiring multiple radio transmissions and therefore occupying limited radio channel resources.

The radio system of the prior art has an architecture in which a control center manages the object characterizations and the dial numbers of the individual subscribers. Interference in the control center can lead to total failure of the radio system, the effects of which can be easily imagined, for example in the case of an airport.

In another example, a method and an apparatus for assigning an object identity (unit identity) to a mobile subscriber terminal (remote unit) in a communications system is known from GB-A-2 354 672. The assignment of the definite object identity takes place after a number of checking steps in, if necessary, all the subscriber terminals, to find out whether a selected object identity has already been assigned to some other subscriber terminal. The checking enquiries and results are communicated via transmitted messages between the subscriber terminals of the communications system.

The requirement for carrying out the checking steps via a number of transmitted messages, which cost time and take up network capacity of the communications system, is a disadvantage of this assignment method and system. For example, all the subscriber terminals of the communications system must as it were match one another, possibly including their users, via the assignment of the object identities. Moreover, an assignment of object identities is necessarily definite, which makes this method or this apparatus unsuitable for communications systems in which it is desirable to assign the same object identity temporarily to a number of subscribers, i.e., to assign it in a redundant manner.

A further disadvantage is that the object identity in GB-A-2 354 672 is not freely structurable. Two different structures of object identities side by side are not possible with this assignment method and system, since during the checking process only object identities having an identical structure can be compared with one another.

The document DE 197 19 955 A1 describes a method for the accessibility of subscribers in a radio communications system in which an object identification is temporarily assigned to subscribers. The temporary object identifications are formed by subscriber data records, which define a total subscriber environment inside a VPN. The assignment of the subscriber data records takes place via so-called clearing points, which are central devices and in which checking mechanisms are used which decide on the possible and correct assignment of the subscriber data records to the subscribers. A disadvantage of this method is that it has central components which monitor the correct assignment of the object identification or subscriber data records. Free structurability of the object characterization is, as already described above, also not given. Two different structures of object identifications side by side are not possible with this method.

### OBJECTS OF THE INVENTION

An object underlying the present invention, therefore, is to provide a communications system, particularly a PMR system in which voice and/or data can be transmitted, wherein this system is provided for a plurality of individual subscribers and overcomes the above-mentioned disadvantages.

The present invention is also based on an object of providing a method of transmitting voice and/or data to a plurality of individual subscribers in a communications system by means of which the above-mentioned disadvantages can also be overcome.

### SUMMARY OF THE INVENTION

According to an aspect of the invention, a communications system is provided where each subscriber has at least one subscriber terminal, at least one object characterization is assigned to each subscriber terminal, and the communications system establishes an object communication from an object communication request of a subscriber, wherein

the assignment of the at least one object characterization takes place only by storing the at least one object characterization in the subscriber terminal, and wherein each subscriber terminal decides on the entry into the object communication requested by the subscriber due to the existing object characterization/s.

In a preferred embodiment, a communications system is a PMR system, i.e., a professional or private mobile radio system, as for instance used in airports.

As used herein, a “subscriber terminal” is a wireless radio appliance, a fixed network appliance, for example a telephone, a mobile telephone or a computer. Further expressions are defined as follows:

An “object,” as used analogously in EP 431 453 of the applicant, is defined in that certain activities are carried out by this object, which are run individually or in groups of changing composition. For example, an object may be, with the example of the airport, connected via the object characterization with the activities to be carried out with it and the role of the person(s) carrying out this activity.

An “object communication” is a communicative connection of the subscribers, the connection having an appropriate object characterization, e.g., a radio connection of a subscriber with its colleagues temporarily active at an object (e.g., special flight number), which is defined by an object characterization.

An “object communication request” is a request, coming from a subscriber of the entire communications system, to build up an object communication or to enter into communication with all subscribers temporarily active at an object via the respective object characterization.

The “establishment of the initial state” of each subscriber terminal of the communications system, usually designated by “initialization,” is divided in the present invention first of all into the assignment of the object characterization by a subscriber or an administration computer and secondly into the storage of the object characterization in the subscriber terminal so that it is ready for communication with other subscriber terminals of the communications system. It is fundamentally known that subscriber terminals, for example mobile communication terminals such as mobile telephones, PMR hand-held devices etc., have a memory in which identification data, such as an object characterization, can be stored.

A decentralized structure is advantageously created by the communications system according to the invention so that a possible weak point, namely a failure of the central unit, which for instance carries out the allocation of the object characterizations or dial numbers in the system of the prior art, carries out tests on plausibility and identity and centrally stores the information, is excluded. Moreover, the radio traffic or the traffic of the data transmitted is significantly reduced, since a previous assignment of dial numbers to object characterizations must not take place prior to the actual voice or data communication.

In an advantageous manner the object characterization must be capable of being input by the subscriber, who has the subscriber terminal. In this manner the assignment of the object characterization to the subscriber terminal is achieved in a simple and flexible manner, which is especially advantageously carried out in a decentralized manner.

Furthermore, the object characterization can also advantageously be input into a subscriber terminal via a subscriber, who has another subscriber terminal. The other subscriber terminal transmits the object characterization to the first subscriber terminal so that this subscriber is also available for a further object for an object communication.

As shown by the above-mentioned exemplary advantages, the communications system according to the invention does not need a central assignment unit, which checks each assignment of an object characterization to a subscriber terminal, e.g., on plausibility and identity. Elaborate examination steps, which occupy radio channel resources, are therefore dispensable.

Communications networks often have managing computers, which manage these networks. According to the invention, the initialization of a subscriber terminal, such as the assignment of the object characterization can advantageously be carried out via such a managing computer.

As mentioned above, the assignment of the object characterization serves for establishing the initial state of the subscriber terminal. Upon receipt of the object characterization by inputting same on the subscriber terminal itself, another subscriber terminal or a managing computer, the object characterization is only locally stored in the storage portion of the subscriber terminal. An adjustment with existing object characterizations or check on plausibility is not carried out.

If several object characterizations are input into a subscriber terminal, this subscriber may participate in several object communications, and be available for the object-related communication in several objects.

Particularly advantageously, the object characterization used in the communication method serves simultaneously as a communication identity, and thus an additional dial number management and assignment of dial numbers to objects can be dispensed with.

Furthermore, the object characterization may advantageously enable a group assignment, by means of which a plurality of subscribers can be assigned to a group. Here different object characterizations can be assigned to different subscribers, or the same object characterization can be assigned to different subscribers, such that the provision of redundant subscribers is enabled.

With the communication method according to an embodiment of the invention, a local and/or chronological assignment of the subscribers to a group can be undertaken. For example the communications system may have a connection to a local tracking system or a GPS system, which knows the local arrangement of the subscribers and their terminals, such that a local assignment is thus enabled. Alternatively or simultaneously, a chronologically predetermined assignment of the subscribers can also take place.

A further great advantage is the flexible parameterization of the object characterization. Preferably the object characterization can be multi-dimensional and the number and length of the individual fields of the object characterization may be freely determined. Thus, the communication method can be adapted to many different object characterizations according to the wishes of the operators. Particularly when changing the parameterization of the object characterization, also by a part of all users of the communications system, the entire system does no longer have to be upgraded by new software. This significantly increases maintainability and manageability of the communications system.

Furthermore, it is advantageous that the object characterization can have presettable parameters. Thus, the object characterization can contain the assignment “listen only,” such that the subscriber whose user terminal has this object characterization cannot take part actively in the communication, but only passively, namely, only by listening. This means that it is possible for individual subscribers to take part in a group but not be able to activate it.

The communications system has the advantage that participation in an object communication can be terminated by the subscriber itself.

The present invention further refers to an embodiment including a method of transmitting voice and/or data to a plurality of individual subscribers in a communications system, particularly in a PMR system. Such a method may include the following features:
at least one subscriber terminal is provided to each subscriber,
at least one object characterization is assigned to each subscriber terminal,
upon the object communication request of a subscriber the communications
system establishes an object communication,
   wherein
the assignment of the at least one object characterization takes place exclusively by storage of the at least one object characterization in the subscriber terminal, and
each subscriber terminal, based on the object characterization/s existing in same, decides on the entry into the object communication.
   In these features the same definitions as mentioned above apply.

By the aid of such a method subscribers can decentrally enter into an object communication with a defined object characterization and transmit or receive voice and/or data to other subscribers, which are determined by the object characterization. The transmission or radio traffic can significantly be reduced compared to conventional systems and the transmission takes place independent of a central unit, i.e., decentrally.

### BRIEF DESCRIPTION OF THE DRAWING FIGURES

The present invention is now described in greater detail with the aid of an exemplary embodiment, but it is naturally not limited to this embodiment. The embodiment is schematically represented with the aid of drawings, in which:

FIG. 1 shows a decentralised communications system according to an exemplary embodiment of the invention, for an example of an airport communication system.

FIG. 2 shows a communications system with a switching device (Main Switch) and two base stations.

FIG. 3 represents schematically various possibilities and assignments on the basis of allotted object characterizations.

FIG. 4 represents schematically the implementation steps of an object communication taking place in the communications system according to an exemplary embodiment of the invention.

### DETAILED DESCRIPTION OF PREFERRED EMBODIMENTS

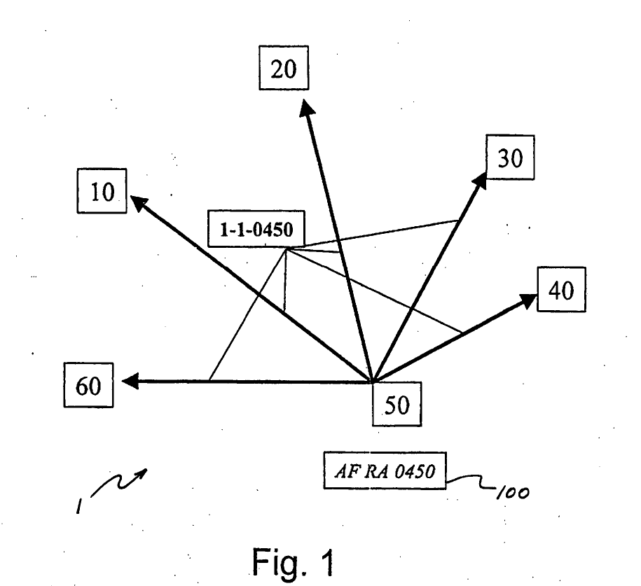

The embodiment shown is a communications system, especially a PMR system for transmitting voice and/or data in an airport. According to FIG. 1, the communications system 1 according to the invention has subscribers 10, 20, 30, 40, 50, 60 who each have a corresponding user terminal.

Subscriber 50 transmits an object communication request 1-1-0450. In the case of the illustrated example, the first numeral “1” means the designation of the airline, the second numeral “1” the activity ramp agent “RA” and the numerals “0450” the flight number, such that this means that subscriber 50 has an enquiry for the ramp agent (RA), e.g., of Air France (AF), with flight number 0450. As represented, direct communication takes place between the user terminal of subscriber 50 and the user terminals of the other subscribers using such an object characterization 100.

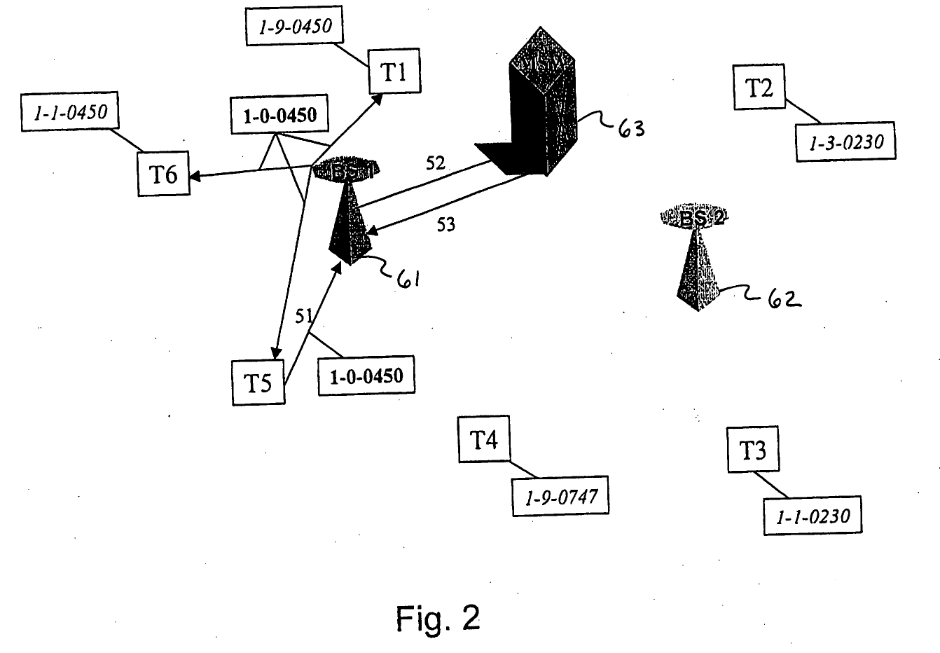

In FIG. 2, a different configuration of a communications System is shown by way of example, having subscribers T1 to T6, two base stations 61, 62 (BS1 and BS2) and a switching Station 63 (Main Switch MSW). The switching station 63 does not perform any assignment tasks with respect to the object characterizations, but for instance fulfills the function of a forwarding of a radio connection from one cell to the other. The base station 62 (BS2) in the example shown is only redundant and is operated only upon failure of base station 61 (BS1). Object characterizations are assigned to the subscribers T1 to T6, as may is clear from the respectively attached exemplary boxes.

Subscriber T5 transmits an object communication request 1-0-0450, the first numeral “1” meaning the airline and the last four numerals meaning the flight number 0450. The central numeral “0” designates a “joker” or a “wild card”: all the subscribers of the airline are addressed with numeral 1 and the flight number 0450.

The connection set-up request goes according to arrow 51 first to Base Station 61BS1. A managing station 63, also called the main switch, is provided to manage all the assignments. The base station 61 BS1 sends the connection set-up request to the main switch 63 MSW as per arrow 52 and the main switch 63 sends it back to Base Station 61 BS1. From there, the connection set-up is transmitted to subscribers T1 to T6, only subscribers T1 and T6 entering the object communication on the basis of the appropriate object characterizations.

Upon failure of base station 61, the signal propagation is implemented via the base station 62 BS2.

In another variant—not shown—, the base stations 61, 62 (BS1 and BS2) can be operated simultaneously, in such a way that some subscribers can only reach, or be reached via, base station 61 BS1 and other subscribers can only reach, or be reached via, base station 62 BS2. Thus, a correspondingly greater communication range is created.

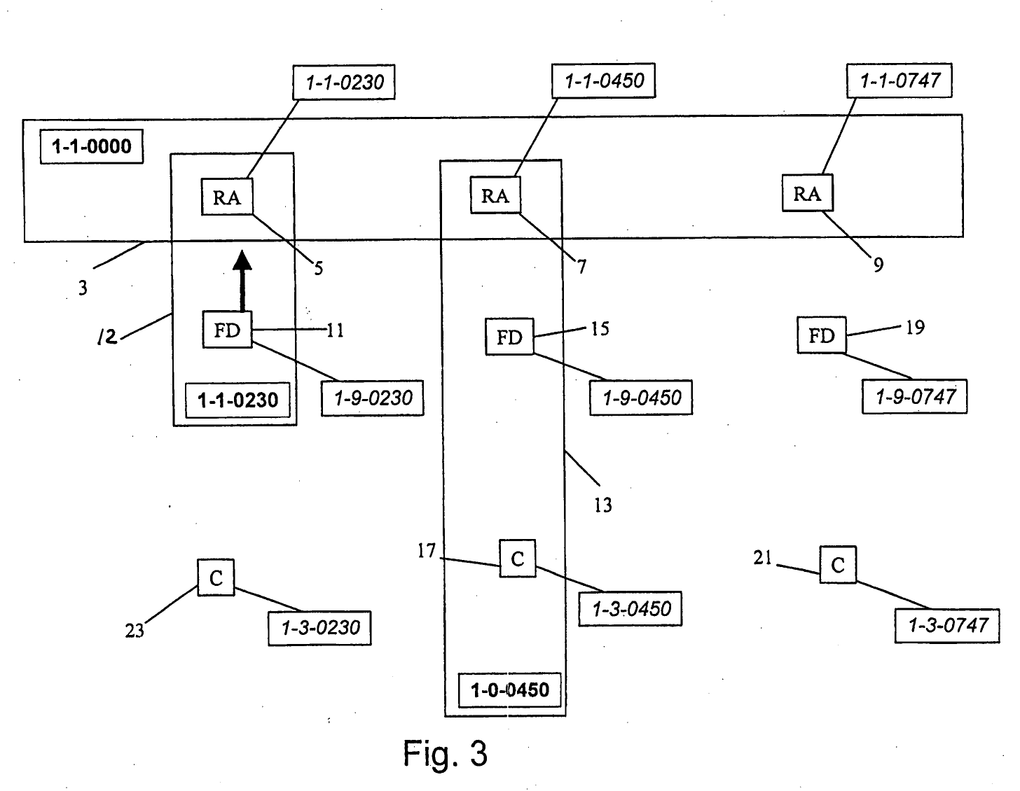

Various possibilities for the decentralized communication are represented in FIG. 3. Within the horizontal bar 3 is represented the plane of the ramp agents RA who can be jointly addressed with a functional object characterization 1-1-0000. The sequence of numerals 0000 means that all the ramp agents who have the coding 1-1 (first numeral “1,” e.g., for the airline Air France), can be jointly addressed independently of the flight number and thus can take place in the object communication. The designation “0000” thus corresponds to a “wild card,” each individual “0” being able to stand as a dummy for one of the numbers 1 to 9 or also for a letter.

With “FD”, Flight Dispatches are addressed which in the example shown are designated with the second numeral “9.”

The object characterization 1-1-0230 is assigned to ramp agent 5, object characterization 1-1-0450 is assigned to ramp agent 7 and object characterization 1-1-0747 is assigned to ramp agent 9. The bar 12 symbolizes the object communication of flight number 0230 which with the addressing 1-1-0230 puts all the subscribers of this flight number in communication. The flight dispatch 11 with the object characterization 1-9-0230 is, on the basis of the latter, in a position to communicate with ramp agent 5 if he requests the object characterization 1-1-0230.

The bar 13 symbolizes the object communication of flight number 0450 which with the addressing 1-0-0450 puts all the subscribers of this flight number in communication, which are in this example the ramp agent 7, the flight dispatch 15 and the catering service C with reference numeral 17. In other words: through the request of a subscriber by means of the object characterization 1-0-0450, all the subscribers of the airline “1” with the flight number “0450” are put into communication with one another, as has already been explained with reference to FIG. 2.

As is also clear from FIG. 3, there is not yet any request for flight 0747 since flight dispatch 19 with object characterization 1-9-0747 and catering service 21 with object characterization 1-3-0747 have not yet been requested. The same is also true for the catering service 23 with object characterization 1-3-0230.

Thus, from FIG. 3 it becomes clear that with appropriate “wild card” object characterizations, as represented with 1-1-0000, all the ramp agents can be addressed, or with the “wild card” object characterization 1-0-0450 all the subscribers relating to flight number 0450 can be addressed. If one wished to address all the catering services C, correspondingly the object characterization 1-3-0000 would have to be requested.

From the above-mentioned description arises thus the simple decentralised possibility of combining into a group, the connection to the corresponding subscribers of the group being able to be set up particularly advantageously by the corresponding object characterization, without additional dial number assignments being necessary, and this leads to a considerable reduction in the radio traffic.

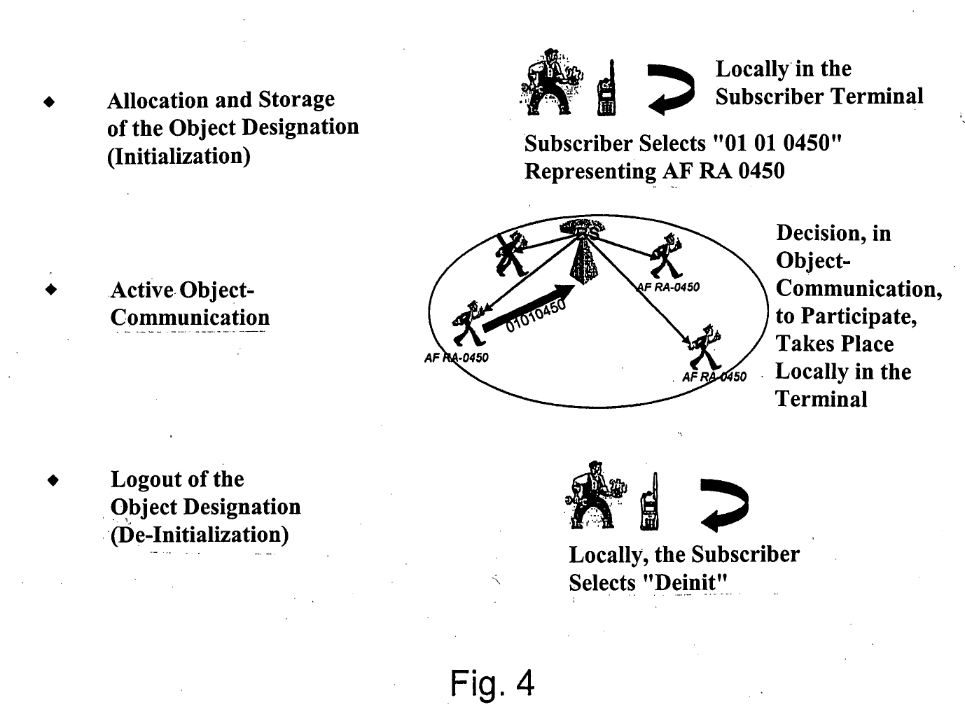

FIG. 4 schematically shows the steps of an object communication exemplarily taking place in the communications system according to an embodiment of the invention. First of all, the subscriber terminal is set into operation or initialized by input of the object characterization, in this case by the subscriber. That means the object characterization is assigned to the subscriber and is stored therein. This takes place locally in the subscriber terminal without adjustment with a central station or other systems. Subsequently, an active object communication with the three subscriber terminals shown is established upon the object communication request with the object designation “01 01 0450.” As soon as one single subscriber wants to cause the end of its participation in an object communication, it dials on its subscriber terminal “deinit,” which causes the assignment of the former object characterization to be annulled.

The parameterised object characterization quoted in the examples, first digit field for the unit, second digit field for the task and digit fields three to six for the object are not limited by the invention to such a coding. The communication method according to the invention or the method of transmitting voice and/or data also enables flexible parameterization of the object characterization. For example, an object characterization can be constructed as follows:

3.2.3.1, having the following meaning: first numeral “3” means three fields, the first field having two places, the second field three places and the third field one place. The fields may be numerical or alphanumerical fields so that an object characterization can have both numbers and letters.

Depending on the particular application, the object characterizations can be set up in a variable manner according to the invention, such that the communication method according to the invention for transmitting voice and/or data is suitable for any number and any structure of individual subscribers.

The flexibility thus achieved therefore enables the communicative connection of the most different levels. For example, from a network Operator's workplace simultaneously a number of airlines or all the airlines can be addressed and all the flight dispatches, etc. The addressing of individual other groups is correspondingly flexible.

The present invention was described by way of example on the basis of an airport communications system. Naturally, the present invention can also be applied to any other communications systems, e.g., for ports, emergency rescue systems, police organizations, shipping agents of any type (taxi, bus, van etc.) and the like which during communication transmit and receive voice and/or data. Pure radio systems, hardwired systems and a combination of the two can be used here.

The object characterizations can also be configured in such a way, that part of the object characterization goes to the signalling channel of the communications network when the object communication is set up, this network addressing the user terminals assigned to this object characterization and causing them to participate in the object communication, and another part of the object characterization goes to the communication channel which serves to transmit voice and/or data.

Thus, with the present invention a universally applicable, decentralised communication method is created in which flexible and free parameterization of the object characterization is possible. The dial number assignment necessary in previous systems in addition to the object characterization is avoided, since the object characterization takes the place of the dial number.

What is claimed is:

1. A PMR communications system, for transmitting voice and/or data, for a plurality of individual subscribers, comprising:
at least one subscriber terminal for each subscriber in the system; and
at least one object characterization is assigned to each subscriber terminal;
wherein
upon an object communication request of a subscriber, the communications system establishes an object communication, characterized in that an assignment of the at least one object characterization takes place only by storing the at least one object characterization in the subscriber terminal, and in that each subscriber terminal decides on the basis of the object characterization(s) contained therein whether to enter into the object communication requested by the subscriber.

2. A communications system as claimed in claim 1, characterized in that the object characterization is adapted to be input into the subscriber terminal by the subscriber accessing the subscriber terminal.

3. A communications system as claimed in claim 1, characterized in that the object characterization is adapted to be input into the subscriber terminal by a subscriber accessing another subscriber terminal.

4. A communications system as claimed in claim 1, characterized in that a managing computer managing a communications network transmits the object characterization to a subscriber terminal.

5. A communications system as claimed in claim 1, characterized in that the object characterization serves as communications identity.

6. A communications system as claimed in claim 1, characterized in that the object characterization enables a group assignment by which a plurality of subscribers can be assigned to one group.

7. A communications system as claimed in claim 6, characterized in that one of a local and a chronological assignment of subscribers to a group is made.

8. A communications system as claimed in claim 1, characterized in that parameterization of the object characterization is adapted to be freely structurable.

9. A communications system as claimed in claim 1, characterized in that the object characterization includes presettable parameters.

10. A communications system as claimed in claim 9, characterized in that control inputs by the subscriber are limited to modification of determinable functions by the object characterization.

11. A communications system as claimed in claim 1, characterized in that termination of participation in the object communication is adapted to be made by the subscriber.

12. A method of transmitting voice and/or data to a plurality of individual subscribers in a PMR communications system, comprising the steps of:
assigning for each subscriber at least one subscriber terminal;
assigning at least one object characterization to each subscriber terminal;
upon receipt of an object communication request of a subscriber the communications system preparing an object communication characterized in that:
assignment of the at least one object characterization takes place only by storing the at least one object characterization in the subscriber terminal, and in that each subscriber terminal decides on the basis of object characterization(s) contained therein whether to enter into the object communication requested by the subscriber.

13. A method as claimed in claim 12, further comprising inputting the object characterization into the subscriber terminal by the subscriber accessing the subscriber terminal.

14. A method as claimed in claim 12, further comprising inputting the object characterization into the subscriber terminal by a subscriber who has another subscriber terminal.

15. A method as claimed in claim 12, further comprising transmitting the object characterization to the subscriber terminal by a managing computer managing the communications network.

16. A method as claimed in claim 12, further comprising identifying a communication by using the object characterization.

17. A method as claimed in claim 12, further comprising assigning a plurality of subscribers to one group by using the object characterization.

18. A method as claimed in claim 17, characterized in that the assigning effects a local assignment of the subscribers to a group.

19. A method as claimed in claim 12, characterized in that parameterization of the object characterization is adapted to be freely structurable.

20. A method as claimed in claim 12, characterized in that the object characterization has presettable parameters.

21. A method as claimed in claim 20, characterized in that the subscriber terminals are adapted to be limited to determinable functions by the object characterization.

22. A method as claimed in claim 12, characterized in that termination of participation in the object communication is carried out by the subscriber.

23. A method as claimed in claim 12, wherein each subscriber terminal is one of a wireless radio and a fixed network device, and wherein the fixed network device is one of a wired telephone and a mobile telephone.
